(19) United States
(12) Patent Application Publication
(10) Pub. No.: US 2018/0141505 A1
(43) Pub. Date: May 24, 2018

(54) CURVATURE REGULATING MEMBER AND POWER SUPPLY DEVICE

(71) Applicant: Yazaki Corporation, Tokyo (JP)

(72) Inventors: Tsukasa Sekino, Shizuoka (JP); Mitsunobu Kato, Shizuoka (JP); Tatsuya Otsuka, Shizuoka (JP); Masaki Yokoyama, Shizuoka (JP)

(21) Appl. No.: 15/718,971

(22) Filed: Sep. 28, 2017

(30) Foreign Application Priority Data
Nov. 22, 2016 (JP) 2016-226474

(51) Int. Cl. B60R 16/027; B60R 16/02; H02G 3/04

(52) U.S. Cl. CPC B60R 16/027; H02G 3/0475; H02G 3/0468; B60R 16/0215

(57) ABSTRACT

A curvature regulating member with increased rigidity and a power supply device having the curvature regulating member is provided. A plurality of member pieces is arranged along a wire harness. A flexible connection couples the member pieces adjacent to each other. A curvature regulating member regulates a curvature of the wire harness on a XY plane by abutting the adjacent member pieces one another. The member piece includes a first projection and a second projection. The first projection and the second projection in the adjacent member pieces make contact with one another in the width direction, and thereby a position of the member piece in the width direction is regulated.

The present invention relates to a curvature regulating member for controlling a curvature of a wire harness and a power supply device to which the curvature regulating member is applied.

### BACKGROUND OF THE INVENTION

As the above conventional curvature regulating member, for example, it is suggested in a Patent Literature 1. In FIGS. 7 and 8, a curvature regulating member 10 disclosed in the Patent Literature 1 is shown. As shown FIGS. 7 and 8, the curvature regulating member 10 is arranged along a wire harness, and is a member for controlling the wire harness 20 so that the wire harness 20 is not curved with a curvature radius equal or less than a reference radius. The curvature regulating member 10 has a plurality of curved portions 11, and a coupling hinge 12 coupling the curved portions 11. The plurality of the curved portions 11 are arranged along the wire harness 20, and are formed in a substantially U-shaped cross section. The coupling hinge 12 is provided so as to couple the curved portions 11 at an outer side of the curved shape.

According to the above curvature regulating member 10, as shown in FIG. 7, when the curvature regulating member 10 is curved, the adjacent curved portions 11 abut against each other. When a load is applied in the width direction, there is a problem such that he curved portions 11 are displaced in the width direction, and thereby rigidity is decreased. Further, as shown in FIG. 8, when a load is applied to the curvature regulating member 10 in the height direction, there is a problem such that the curved portion 11 buckles, and thereby the curvature regulating member 10 is bent.

Patent Literature 1: JP 2016-136809 A

### SUMMARY OF THE INVENTION

In view of the foregoing problem, an object of the present invention is to provide a curvature regulating member increasing rigidity and a power supply device having the curvature regulating member.

A curvature regulating member of the present invention includes a plurality of member pieces arranged along a wire harness; and a flexible connection coupling the member pieces adjacent to each other. The curvature regulating member regulates a curvature of the wire harness on a predetermined plane by contact with the member pieces adjacent to each other, and each of the adjacent member pieces includes a width regulating portion for regulating a position of each of the member pieces in a width direction perpendicular to both a longitudinal direction of the wire harness and a height direction perpendicular to the plane by contact with the adjacent member pieces in the width direction.

Further, in the curvature regulating member of the present invention, each of the adjacent member pieces includes a height regulating portion for regulating a position of the member piece in the height direction by contact with the adjacent member pieces in the height direction.

Further, in the curvature regulating member of the present invention, the width regulating portion arranged in one of the adjacent member pieces is constituted by a first projection projecting toward the other of the adjacent member pieces, the width regulating portion arranged in the other of the adjacent member pieces is constituted by a second projection projecting toward the one of the adjacent member pieces, the height regulating portion arranged in the one of the adjacent member pieces is constituted by the first projection, the first projection having an opening at the other of the adjacent member pieces and having a groove provided along the width direction, and the height regulating portion arranged in the other of the adjacent member pieces is constituted by a third projection to be inserted from the opening into the groove.

Further, a power supply device of the present invention is provided in a vehicle having a vehicle body and a slide member, and electrically connects the vehicle body and the slide member. The power supply device has a wire harness arranged between the vehicle body and the slide member; and the curvature regulating member arranged along the wire harness and described above.

According to the curvature regulating member of the present invention, the width regulating portion is provided in each of the adjacent member pieces. Therefore, displacement of the adjacent member pieces 131 in the width direction can be prevented, and thereby rigidity can be increased.

Further, according to the curvature regulating member of the present invention, each of the adjacent member pieces includes the height regulating portion. Therefore, rigidity of the member piece in the height direction can be improved, and buckling in the height direction can be suppressed.

Further, according to the curvature regulating member of the present invention, the width regulating portion and the height regulating portion can be provided with simple structure.

According to the power supply device of the present invention, the width regulating portion is provided in each of the adjacent member pieces. Therefore, displacement of the adjacent member pieces 131 in the width direction can be prevented, and thereby rigidity can be increased.

### BRIEF DESCRIPTION OF THE DRAWINGS

FIG. 1 is a view showing a power supply device in which a curvature regulating member according to one embodiment of the present invention is applied;

FIG. 2 is a perspective view of one of a plurality of member pieces constituting the curvature regulating member shown in FIG. 1 as a typical example;

FIG. 3 is a cross-sectional view taken along the line I-I in FIG. 2;

FIG. 4 is a front view, a side view, and a top view of the member piece shown in FIG. 2;

FIG. 5 is a view showing a state that the curvature of the curvature regulating member shown in FIG. 1 in a connection side in the width direction as an inner side is possible to be bent;

FIG. 6 is a view showing a state that the curvature of the curvature regulating member in the connection side in the width direction as an outer side is regulated;

FIG. 7 is an explanatory diagram so as to explain a problem of a conventional curvature regulating member; and

FIG. 8 is an explanatory diagram so as to explain a problem of a conventional curvature regulating member.

### DESCRIPTION OF THE PREFERRED EMBODIMENT

Hereafter, a curvature regulating member and a power supply device according to one embodiment of the present invention will be explained.

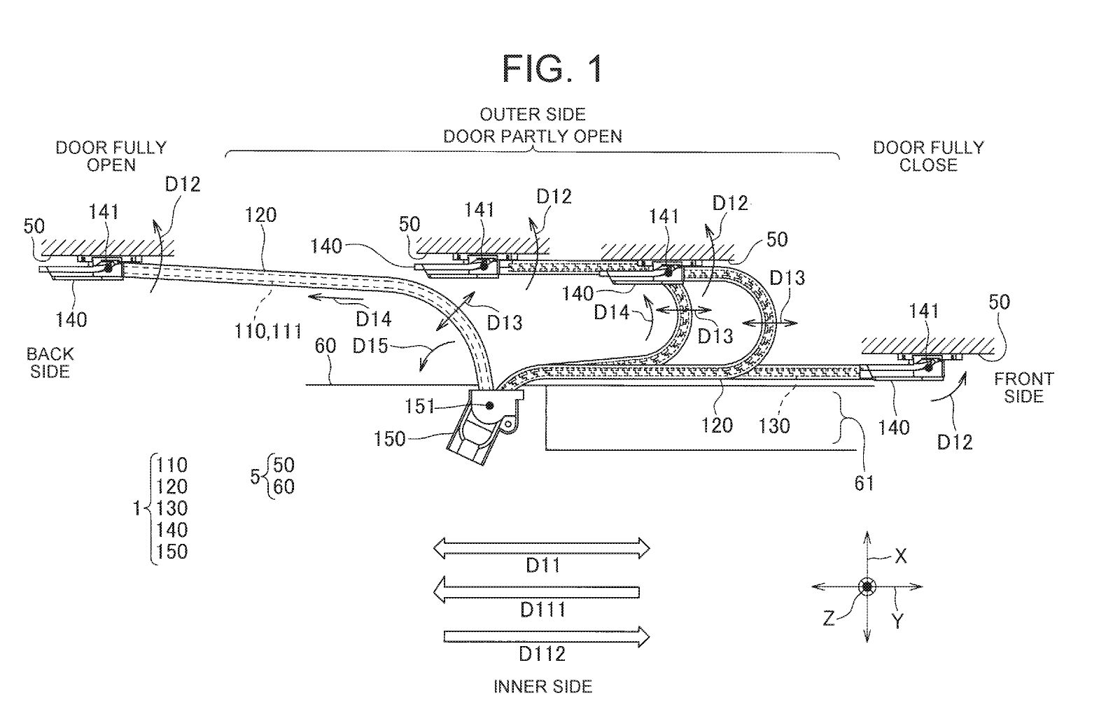

FIG. 1 is a diagram showing a power supply device to which a curvature regulating member according to the embodiment of the present invention is applied. The power supply device 1 of the embodiment in the present invention is mounted on a vehicle 5. The power supply device 1 is a device for supplying power via a wire harness 110 from power source which is not shown and is located at a vehicle body side 60 to an electronic device which not shown and is located at a slide door 50. Further, in FIG. 1, a right side in the drawing corresponds to a front side of the vehicle 5, a left side in the drawing corresponds to a back side of the vehicle 5, an upper side in the drawing corresponds to an outer side of the vehicle 5, and a lower side in the drawing corresponds to an inner side of the vehicle 5. Further, a X direction in the drawing is a horizontal direction of the vehicle 5, a Y direction is a front-back direction of the vehicle 5, and a Z direction is a vertical direction of the vehicle 5.

The power supply device 1 has a wire harness 110, a corrugated tube 120, a curvature regulating member 130, a door side holding portion 140, and a vehicle body side holding portion 150. The wire harness 110 is configured by bundling a plurality of electric wires 111, and a part of the wire harness 110 between the vehicle body 60 and the slide door 50 is inserted into the corrugated tube 120 which is a flexible tube made of resin.

The power supply device 1 has a wire harness 110, a corrugated tube 120, a curvature regulating member 130, a door side holding portion 140, and a vehicle body side holding portion 150. The wire harness 110 is configured by bundling a plurality of electric wires 111, and a part of the wire harness 110 between the vehicle body 60 and the slide door 50 is inserted into the corrugated tube 120 which is a flexible tube made of resin.

The electrical wire 111 is not only a power wire for supplying power but also may include a signal wire for sending and receiving an electric signal between a control device which is not shown and is arranged on the vehicle body 60 and the electric device which is not shown and is arranged on the slide door 50. The curvature regulating member 130 is arranged along the wire harness 110 such that it is surrounded between an inner surface of the corrugated tube 120 and the wire harness 110 in a circumferential direction. The curvature regulating member 130 will be explained in detail later.

A one end of the corrugate tube 120 at a slide door 50 side is swingably held to the door side holding portion 140 on a XY plane around a door side rocking shaft 141 along the Z direction. The door side holding portion 140 is fixed in the slide door 50. The door side rocking shaft 141 arranged on the door side holding portion 140 is an axis parallel to the slide door 50 and perpendicular to an opening and closing direction D11 of the slide door 50 (Y direction being the front-back direction).

Since the corrugated tube 120 is held by the door side holding portion 140, a part of the wire harness 110 at the slide door 50 side is swingably held on the XY plane around the door side rocking shaft 141. The wire harness 110 at the slide door 50 side emerges from the one end of the corrugated tube 120 at the slide door 50 side. Furthermore, the wire harness 110 emerges from the door side holding portion 140 through a passage of an inner portion of the door side holding portion 140 not shown, and then extends to the electric device of the slide door 50.

On the other hand, one end of the corrugated tube 120 at the vehicle body 60 is swingably held to a vehicle body side holding portion 150 in the XY plane around a vehicle body side rocking shaft 151 along the Z direction. The vehicle body side holding portion 150 is fixed in the vehicle body 60. The vehicle body side rocking shaft 151 arranged on the vehicle body side holding portion 150 is an axis parallel to the slide door 50 and perpendicular to the opening and closing direction D11 of the slide door 50.

By holding the corrugated tube 120 with the vehicle body side holding portion 150, the wire harness 110 is held such that a part thereof at the vehicle body 60 side is swingable on the XY plane around the vehicle body side rocking shaft 151. The wire harness 110 at the vehicle body 60 side emerges from one end of the corrugated tube 120 at the vehicle body 60 side. Furthermore, the wire harness 110 emerges from the vehicle body side holding portion 150 through a passage of an inner portion of the vehicle body side holding portion 150 not shown, and then extends to a power source or control device not shown in the vehicle body 60.

As shown in FIG. 1, when the slide door 50 is fully closed, the door side holding portion 140 is located on a front side of the vehicle 5 against the vehicle body side holding portion 150. The corrugated tube 120, that is, the wire harness 110 of the inner side portion thereof linearly extends between the vehicle body side holding portion 150 and the door side holding portion 140.

When the slide door 50 is opened in an opening direction D111 toward the back of the vehicle 5, in its initial stage, the one end of the corrugated tube 120 at the slide door 50 side is swung as below. More specifically, when the slide door 50 is fully closed, the one end of the corrugated tube 120 at the slide door 50 side is located in the vehicle body side holding portion side (back side) than the door side rocking shaft 141. When the slide door 50 is opened, the above one end is swung at the front side around the door side rocking shaft 141 on the XY plane. When the slide door is partly opened, the one end is located in a side (front side) away from the vehicle body side holding portion 150 than the door side rocking shaft 141. In the door side holding portion 140, a coil spring is arranged so as to prompt such swinging. The coil spring energizes the one end of the corrugated tube 120 at the slide door 50 side in an energizing direction D12.

Due to the above swinging at the initial stage of opening of the slide door 50, when subsequently moving the slide door 50 in the opening direction D111, that is, when the slide door 50 is partly opened, the wire harness 110 of the inner portion of the corrugated tube 120 is bent as below. More specifically, as shown in FIG. 1, the wire harness 110 is curved such that it makes a U-shape on the XY plane at the front side of the vehicle 5 from the vehicle body side holding portion 150 toward the door side holding portion 140 and is bent toward the outer side of the vehicle body 60.

Also, hereinafter, without particular mention, the wire harness 110 of the inner portion of the corrugated tube 120 may be simply referred to as the wire harness 110.

When the slide door 50 is moved in the opening direction D111, an arm in the U-shape of the wire harness 110 at the slide door 50 side linearly extends to the front side of the vehicle 5 by energizing it in the energizing direction D12 at the door side holding portion 140. Owing to the actions of each of those portions and the movement of the curvature regulating member 130 described below, the U-shape of the wire harness 110 on the XY plane during the movement of the slide door 50 is adjusted.

While the slide door 50 is moved in the opening direction D111, the arm of the wire harness 110 at the slide door 50 in the U-shape is extended, and the arm thereof at the vehicle body 60 become shortened. Then, in a stage that the arm of the wire harness 110 at the vehicle body 60 is shortened to a certain extent, the one end of the wire harness at the vehicle body side is swung toward the back side of the vehicle 5 in a swing direction D15. Thereafter, in this state, the slide door 50 is moved in the opening direction D111, and then reaches a full opening state.

When the slide door 50 is closed in the closing direction D112 from the full opening state, the wire harness 110 traces the reverse movement of the above movement when the above slide door 50 is opened. Firstly, in its initial stage, the one end of the wire harness 110 at the vehicle body 60 side is swung in the reverse direction of the above swing direction D15, and thereby the wire harness 110 has a U-shape on the XY plane. Thereafter, in a stage that the slide door 50 continues to move in the closing direction D112 and the arm at the slide door 50 side in the U-shape is shortened to a certain extent, the one end of the wire harness 110 at the slide door side swings as below. That is, in this stage, the one end of the wire harness 110 at the slide door 50 side swings toward the back side of the vehicle 5 being a reverse side of the energizing direction D12 against the energizing force in door side holding portion 140. Thereafter, the slide door 50 is moved in the closing direction D112 in this stage, and the wire harness 110 is extended linearly and reaches a full closing state.

Herein, an end portion in a floor of the vehicle body 60 at the slide door 50 side is a step 61 formed to be lower by one step and where a person places his or her foot when riding a vehicle. When opening and closing the slide door 50, the arm of the wire harness 110 having the U-shape at the vehicle body 60 side passes near the step 61 on the XY plane.

At this time, generally, in a field of the power supply device attached to the slide door of the vehicle, there is a desire to suppress a bulge toward the vehicle body side when the wire harness is curved during opening and closing of the slide door. Therefore, in the embodiment of the preset invention, in order to restrict the curvature in which the wire harness 110 is inflated toward the vehicle body 60 side like that, the curvature regulating member 130 is provided to be located along the wire harness 110. The curvature regulating member 130 regulates the curvature of the wire harness 110 on the XY plane. Further, the curvature regulating member 130 allows the curvature such that one side in the width direction D13 (back side of the vehicle 5 in the embodiment of the present invention) becomes an inner side. Meanwhile, regarding the curvature like that the other side in the width direction D13 becomes an inner side (front side of the vehicle 5 in the embodiment of the preset invention), the curvature regulating member 130 limits the curvature more than a predetermined limit state. Further, the width direction D13 is a direction perpendicular to both the longitudinal direction D14 of the wire harness 110 and the Z direction being a height direction perpendicular to the XY plane.

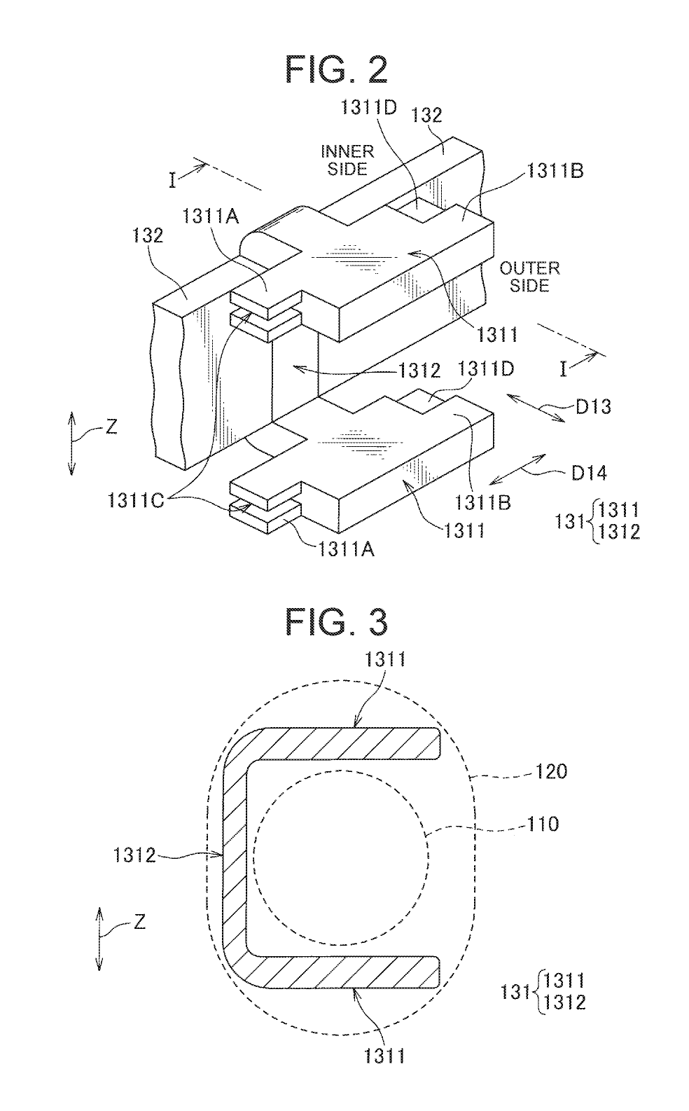

FIG. 2 is a perspective view showing one example of a plurality of member pieces 131 constituting the curvature regulating member 130 shown in FIG. 1. FIG. 3 is a cross-sectional view taken along the line I-I in FIG. 2.

As shown in FIG. 1, the curvature regulating member 130 is located between an inner surface of the corrugated tube 120 and the wire harness 110 such that the wire harness 110 is surrounded in a circumferential direction and the curvature is guided along the wire harness 110. The curvature regulating member 130 has substantially the same length as the corrugated tube 120.

The curvature regulating member 130 has a plurality of member pieces 131 arranged along the wire harness, and flexible connections 132 coupling adjacent member pieces in the plurality of member pieces 131. In the embodiment of the present invention, the plurality of member pieces 131 and the connections 132 are integrally formed with resin. The plurality of member pieces 131 are arranged along the longitudinal direction D14 of the wire harness 110 side by side. The connections 132 is a flexible member arranged along the wire harness 110 such that they are located in the inner side of the curved shape of the plurality of member pieces 131. The adjacent member pieces 131 are coupled by only the connection 132. Thereby, against one of the adjacent member pieces 131, the other thereof is swingably around the connection 132.

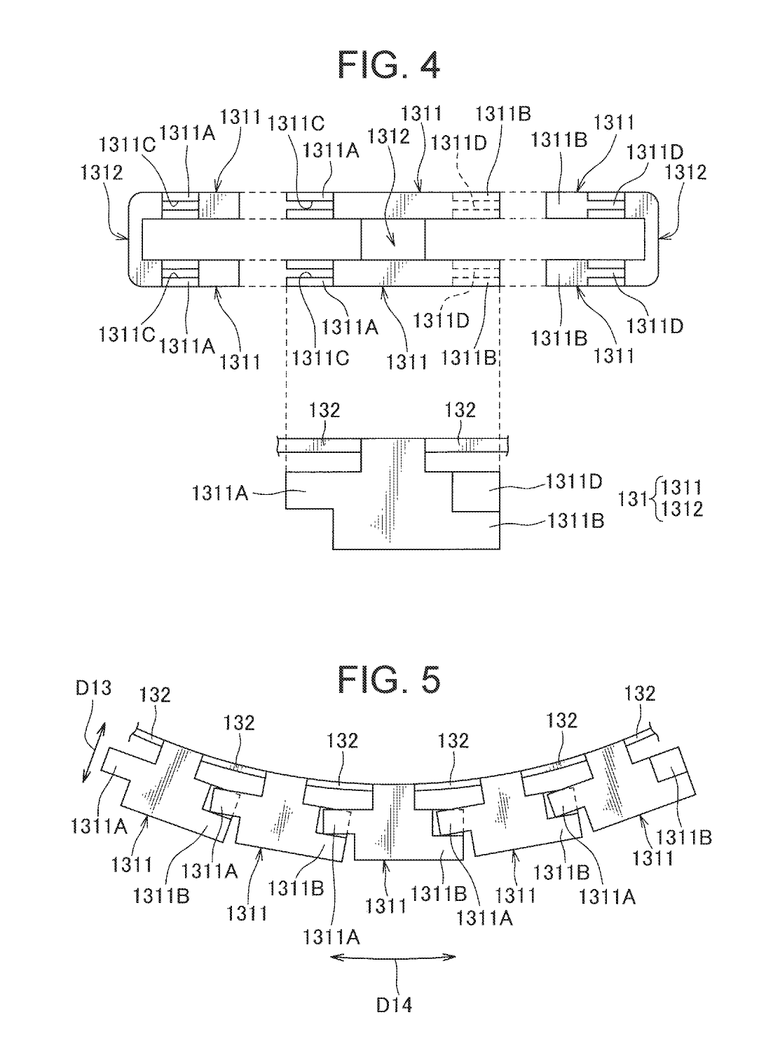

As one representative example is shown in FIGS. 2 to 4, each of the plurality of member pieces 131 has a pair of opposed walls 1311 opposed to each other such that the wire harness 110 is sandwiched between the opposed walls 13111, and a joint wall 1312 joining the pair of opposed walls 1311 to each other. The cross sectional shape of each of the member pieces 131 intersecting with the wire harness 110 in the longitudinal direction D14 is formed with a substantially C-shaped by three walls of the opposed walls and the joint wall 1312 as shown in FIG. 3.

The pair of opposed walls 1311 is arranged to be opposed to each other in the Z direction. As shown in FIG. 2, each of the pair of opposed walls 1311 has a substantially T-shaped in a planer view. A part corresponding to a crossbar of the T-shaped extending in the longitudinal direction D14 of the wire harness 110 is formed to be wide, and a part corresponding to a vertical bar of the T-shaped extending in the width direction D13 is formed to be narrow and short. The base of the narrow part of the T-shaped in each of the opposed walls 1311 is joined to the joint wall 1312. The joint wall 1312 joins the narrow part, and is erected along the Z direction.

Each of the pair of opposed walls 1311 has a first projection 1311A projecting toward the member piece 131 adjacent to one side of the longitudinal direction D14, and a second projection 1311B projecting toward the member piece 131 adjacent to the other side thereof. The first projection 1311A projects from the inner side of the curved shape in an end portion of the opposed wall 1311 at one side in the longitudinal direction D14.

The second projection 1311B projects from the outer side of the curved shape in an end portion of the opposed wall 1311 at the other side in the longitudinal direction D14. Further, as shown in FIG. 5, in a state that the plurality of member pieces 131 are arranged linearly, the first projection 1311A and the second projection 1311A are joined by the connection 132 such that the first projection 1311A of the adjacent member pieces 131 makes contact with and the second projection 1311B thereof in the width direction D13.

Thereby, although a load is applied to the curvature regulating member 130 in the width direction D13, the first projection 1311A and the second projection 1311B in the adjacent member piece 131 come into contact with each other in the width direction D13, and displacement of the member pieces 131 in the width direction can be prevented. Therefore, rigidity of the curvature regulating member 130 can be increased.

Further, as shown in FIG. 5, only a part of the first projection 1311A at a side of the second projection 1311B in the width direction D13 comes into contact with the second projection 1311B, and a part of the first projection 1311A at a side away from the second projection 1311B in the width direction D13 does not touch anywhere on the adjacent member pieces 131. Thereby, the curvature of the curvature regulating member 130 can be allowed, and a position of the adjacent member pieces 131 in the width direction D13 can be restricted.

The first projection 1311A and the second projection 1311B function as a width regulating portion for regulating a position of each of the adjacent member pieces 131 in the width direction by bring the first projection 1311A into contact with the second projection 1311B in the width direction D13 in each of the adjacent member pieces 131. That is, the first projection 1311A constructs the width regulating portion arranged in one of the adjacent member pieces 131, and the second projection 1311B constructs the width regulating portion arranged in the other of thereof.

In the above first projection 1311A, an engaging groove 1311C opening toward one side in the longitudinal direction D14 and arranged along the width direction D13 is provided. The engaging groove 1311C passes through the first projection 1311A in the width direction D13. That is, in both sides of the first projection 1311A in the width direction D13, openings are provided. Further, the depth of the engaging groove 1311C is substantially equal to the height of the first projection 1311A.

Furthermore, in the pair of opposed walls 1311, a third projection 1311D projecting toward the adjacent member pieces 131 at the other side of longitudinal direction D14 is formed. A thickness of the third projection 1311D in the Z direction is thin than that of the first projection 1311A and the second projection 1311B, and the third projection 1311D is inserted into the engaging groove 1311C. In the embodiment of the present invention, the third projection 1311D projects from both an end surface of the opposed wall 1311 at the other side in the longitudinal direction D14 and a side surface of the second projection 1311B at the inner side in the width direction D13.

According to the above structure, although a load is applied to the curvature regulating member 130 in the Z direction, the first projection 1311A of the adjacent member pieces 131 comes into contact with the third projection 1311D inserted into the engaging groove 1311C of the first projection 1311A in the Z direction. Thereby, rigidity of the curvature regulating member 130 in the Z direction can be improved, and buckling in the Z direction can be suppressed.

The above first projection 1311A and the third projection 1311D function as a height regulating portion for regulating a position in the Z direction by bring the first projection 1311A into contact with the third projection 1311D in the Z direction (height direction) arranged on each of the adjacent member pieces 131. That is, the first projection 1311A constructs the height regulating portion arranged in one of the adjacent member pieces 131, and the third projection 1311D constructs the height regulating portion arranged in the other thereof.

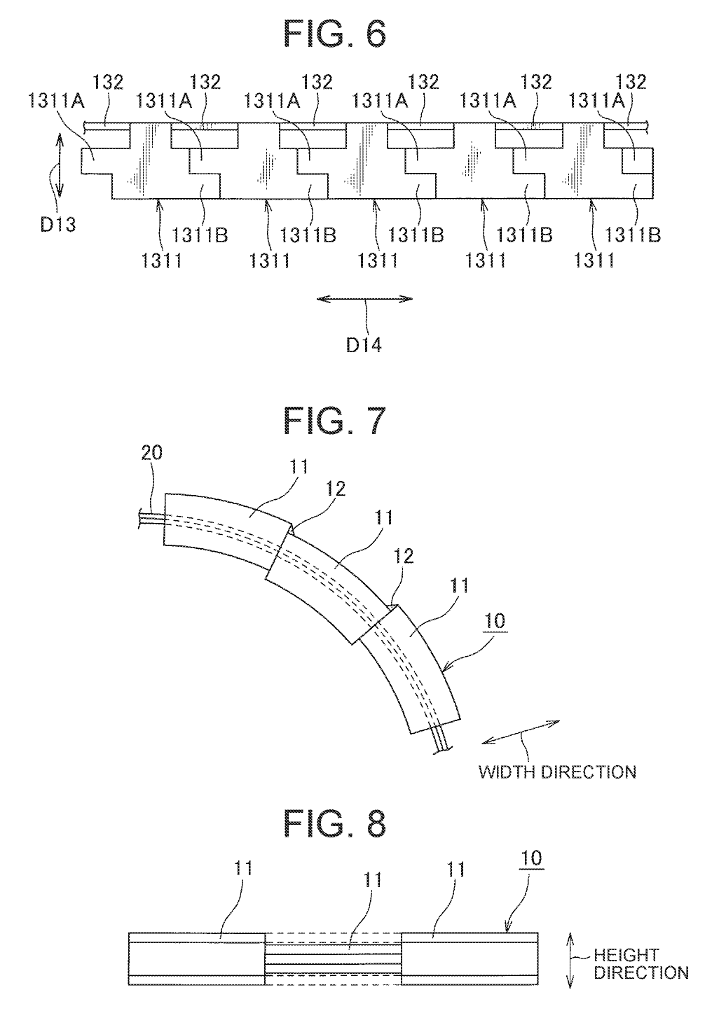

FIG. 5 is a drawing showing a state that the curvature regulating member 130 is able to be curved at a connection 132 side in the width direction D13 as an inner side. FIG. 6 is drawing showing a state that the curvature at the connection 132 side in the width direction D13 as an outer side is regulated by the curvature regulating member 130.

As shown in FIG. 5, in the curvature at the connection 132 side in the width direction as an inner side, while the adjacent member pieces in a curvature position among the plurality of member pieces 131 separate in an opposite side to the connection 132 side, the connection 132 is bent. Thereby, the curvature regulating member 130 is able to be bent. Therefore, the wire harness 110 can be curved at the connection 132 side in the width direction as an inner side. Further, the first projection 1311A and the second projection 1311B in the adjacent member pieces 131 make contact with one another even when the curvature regulating member 130 is curved. Thereby, the first projection 1311A and the second projection 1311B can regulate a position in the width direction D13 even in a state that the curvature regulating member 130 is curved.

Meanwhile, as shown in FIG. 6, in the curvature at the connection 132 side in the width direction D13 as an outer side, the adjacent member pieces 131 in the curved part among the plurality of member pieces 131 are abutted at an opposite side to the connection 132 side. Thereby, the curvature regulating member 130 cannot be curved over a limit state. A state that the adjacent member pieces in the curved part are abutted in the longitudinal direction D14 is the limit state in the curvature at the connection 132 side in the width direction D13. The curvature regulating member 130 cannot be curved over the limit state at the connection 132 side in the width direction D13 as an outer side. Thereby, in the wire harness 110, with regard to the curvature at the connection 132 side in the width direction D13 as an outer side, the curvature such that the curvature regulating member 130 is curved over the limit state is regulated.

Further, according to the above embodiment, the engaging groove 1311C is provided in the first projection 1311A arranged in one of the adjacent member pieces 131, and the third projection 1311D inserted into the engaging groove 1311C is provided in the other of the adjacent member pieces 131, but the present invention is not limited thereto. When rigidity of the member piece 131 in the Z direction is sufficiently high, it is not necessary to provide the engaging groove 1311C and the third projection 1311D.

Further, according to the above embodiment, the engaging groove 1311C is arranged in the first projection 1311A of the member piece 1311, but it is not limited thereto. It may be possible to provide the engaging groove 1311C in a place different from the first projection 1311A.

Furthermore, according to the above embodiment, the connection 132 is provided such that end portions at one side of the adjacent member pieces 131 in the width direction D13 are coupled, but it is not limited thereto. The connection 132 may be provided such that center portions of the adjacent member pieces 131 in the width direction are coupled.

Further, according to the above embodiment, as the slide member, the slide door 50 is described as an example, but it is not limited thereto. The slide member may be a slide sheet.

Also, the present invention is not limited to the above embodiment. That is, various changes and modifications can be made with the scope of the present invention.

### REFERENCE SIGNS LIST

1 power supply device
50 slide door (slide member)
60 vehicle body
110 wire harness
130 curvature regulating member
131 member piece
132 connection
1311A first projection (width regulating portion, height regulating portion)
1311B second projection (width regulating portion)
1311C engaging groove
1311D third projection (height regulating portion)
D14 longitudinal direction
D13 width direction

1. A curvature regulating member comprising:
a plurality of member pieces arranged along a wire harness; and
a flexible connection coupling the member pieces adjacent to each other,
wherein the curvature regulating member regulates a curvature of the wire harness on a predetermined plane by contact with the member pieces adjacent to each other, and
wherein each of the adjacent member pieces includes a width regulating portion for regulating a position of each of the member pieces in a width direction perpendicular to both a longitudinal direction of the wire harness and a height direction perpendicular to the plane by contact with the adjacent member pieces in the width direction.

2. The curvature regulating member according to claim 1, wherein each of the adjacent member pieces includes a height regulating portion for regulating a position of the member piece in the height direction by contact with the adjacent member pieces in the height direction.

3. The curvature regulating member according to claim 2, wherein
the width regulating portion arranged in one of the adjacent member pieces is constituted by a first projection projecting toward the other of the adjacent member pieces,
the width regulating portion arranged in the other of the adjacent member pieces is constituted by a second projection projecting toward the one of the adjacent member pieces,
the height regulating portion arranged in the one of the adjacent member pieces is constituted by the first projection, the first projection having an opening at the other of the adjacent member pieces and having a groove provided along the width direction, and
the height regulating portion arranged in the other of the adjacent member pieces is constituted by a third projection to be inserted from the opening into the groove.

4. A power supply device provided in a vehicle having a vehicle body and a slide member and electrically connecting the vehicle body and the slide member, comprising:
a wire harness arranged between the vehicle body and the slide member; and
the curvature regulating member arranged along the wire harness and described in claim 1.

5. A power supply device provided in a vehicle having a vehicle body and a slide member and electrically connecting the vehicle body and the slide member, comprising:
a wire harness arranged between the vehicle body and the slide member; and
the curvature regulating member arranged along the wire harness and described in claim 2.

6. A power supply device provided in a vehicle having a vehicle body and a slide member and electrically connecting the vehicle body and the slide member, comprising:
a wire harness arranged between the vehicle body and the slide member; and
the curvature regulating member arranged along the wire harness and described in claim 3.
